(19) United States
(12) Patent Application Publication
(10) Pub. No.: US 2005/0272407 A1
(43) Pub. Date: Dec. 8, 2005

(54) Mobile telephone

(75) Inventor: Manabu Kayamori, Kanagawa (JP)

Correspondence Address: PEARNE & GORDON LLP, 1801 EAST 9TH STREET, SUITE 1200, CLEVELAND, OH, 44114-3108, US

(73) Assignee: MATSUJSHITA ELECTRIC INDUSTRIAL CO., LTD, OSAKA (JP)

(21) Appl. No.: 10/523,905

(22) PCT Filed: Jan. 23, 2004
(86) PCT No.: PCT/JP04/00410

§ 371 Date: Jan. 28, 2005

(30) Foreign Application Priority Data
Jan. 23, 2003 (JP) 2003-015086

(51) Int. Cl. H04B 1/38

(52) U.S. Cl. 455/412.1; 455/567

(57) ABSTRACT

It is an object of the present invention to provide a portable telephone in which external sound can be used as a call receiving sound and a pause of sound can be avoided even when the switching operation of a base station is generated during reproducing the call receiving sound.

Sound picked up by a microphone (180) is subjected to an AD conversion, then encoded by an ADPCM system in an encoding part (141) and stored in an ADPCM encoded data storing area (150b). The stored audio data of a partner to talk with is encoded by the ADPCM system in the encoding part (141) via a digital audio signal processing part (122) and stored in the ADPCM encoded data storing area (150b). Upon receiving a call, the stored data is read, decoded to an analog audio signal in a decoding part (142) and outputted as the call receiving sound from a speaker (181) via an audio output circuit (136). Since the decoding part (142) does not depend on the operation of a communication control part (121), even when the communication control part (121) is reset by switching a channel during reproducing the call receiving sound, the pause of the call receiving sound is nor generated.

### TECHNICAL FIELD

The present invention relates to a portable telephone having a sound reproducing function and more particularly to a portable telephone that can use recorded sound as call receiving sound.

### BACKGROUND ART

A portable telephone having a voice or sound memory function capable of recording the voice of a user has been usually known. Further, a portable telephone having a function for selectively generating a different call receiving sound for each sender has been known. Further, a portable telephone has been also known in which the name of a sender previously registered is converted to an audio signal by an ADPCM (Adaptive Differential Pulse Code Modulation) circuit upon receiving a call and the audio signal is received as a call receiving sound so that the sender can be easily identified. (See Patent Document 1)

(Patent Document 1) JP-A-2000-324228

However, a portable telephone has not been yet realized that can record the voice of a partner to talk with the user to use the recorded voice as a call receiving sound by using the voice or sound memory function. In the voice or sound memory function of the usual portable telephone, a DSP (Digital Signal Processor) for controlling a communication control function for selecting a base station serves as a function for decoding recorded audio data. Accordingly, when the recorded audio data is used as a call receiving sound, during reproducing the call receiving sound, that is, when the switching operation of the base station (switching of a communication channel) is generated during decoding the call receiving sound, the call receiving sound has a break in sound. When the base station is switched, the DSP is reset. At that time, the decoding operation of the audio data is stopped. Further, after the base station is switched, when the call receiving sound is tried to be regenerated, all settings need to be carried out relative to the DSP, so that the break of sound is generated.

The present invention is proposed to solve the above described problems of a related art and it is an object of the present invention to provide a portable telephone in which external sound or the voice of a partner to talk with a user can be used as call receiving sound and the call receiving sound can be avoided from being broken even when the switching operation of a base station is generated during reproducing the call receiving sound.

### DISCLOSURE OF THE INVENTION

In order to achieve the above-described object, a portable telephone according to the present invention comprises: a sound picking up unit for picking-up external sound; an audio encoding unit for encoding an audio signal picked up by the sound picking up unit; an encoded data storing unit for storing the audio data encoded by the audio encoding unit; an audio decoding unit for decoding the audio data stored in the encoded data storing unit; a call receiving sound output unit for outputting the audio data decoded by the audio decoding unit as a call receiving sound; and a communication control unit for switching a base station. The function of the audio decoding unit is provided in another circuit block that does not depend on the operation of a circuit block functioning as the communication control unit.

Since the portable telephone is constructed as described, the external sound is picked up by the sound picking up unit, the audio signal thereof is encoded to the audio data by the audio encoding unit and the audio data is stored (recorded) in the encoded data storing unit. The audio data stored in the encoded data storing unit is decoded to the audio signal by the audio decoding unit and the audio signal is outputted as the call receiving sound by the call receiving sound output unit. At that time, a channel is switched during decoding the audio data by the audio decoding unit. Even at that time, since the function of the audio decoding unit is provided in another circuit that does not depend on the operation of the circuit block functioning as the communication control unit, a break of the call receiving sound is not generated.

Thus, according to this portable telephone, the external sound such as the voice of a user can be used as the call receiving sound. Further, even when the channel is switched during reproducing the call receiving sound, the break of the call receiving sound can be avoided.

Further, a portable telephone of the invention comprises: an audio recording unit for recording an audio signal of a partner to talk with; an audio encoding unit for encoding the audio signal recorded by the audio recording unit; an encoded data storing unit for storing the audio data encoded by the audio encoding unit; an audio decoding unit for decoding the audio data stored in the encoded data storing unit; a call receiving sound output unit for outputting the audio data decoded by the audio decoding unit as a call receiving sound; and a communication control unit for selecting and switching a base station. The function of the audio decoding unit is provided in another circuit block that does not depend on the operation of a circuit block functioning as the communication control unit.

Since the portable telephone is constructed as described, the voice of the partner to talk with is recorded by the audio recording unit, the audio signal thereof is encoded to the audio data by the audio encoding unit and the audio data is stored in the encoded data storing unit. The audio data stored in the encoded data storing unit is decoded to the audio signal by the audio decoding unit and the audio signal is outputted as the call receiving sound by the call receiving sound output unit. At that time, a channel is switched during decoding the audio data by the audio decoding unit. Even at that time, since the function of the audio decoding unit is provided in another circuit that does not depend on the operation of the circuit block functioning as the communication control unit, a break of the call receiving sound is not generated.

Thus, according to this portable telephone, the voice of the partner to talk with a user can be used as the call receiving sound. Further, even when the channel is switched during reproducing the call receiving sound, the break of the call receiving sound can be avoided.

Further, in the portable telephone according to the present invention, the audio encoding unit desirably encodes the inputted audio signal by an ADPCM system and the audio decoding unit desirably decodes the inputted audio data by the ADPCM system.

As an encoding/decoding system of the audio signal, the ADPCM system is employed, so that a quantity of the audio data can be reduced. Thus, a memory capacity necessary for the encoded data storing unit can be suppressed.

Further, in the portable telephone according to the present invention, a noise component removing unit is desirably provided for removing the noise component of the audio signal inputted to the audio encoding unit.

The noise component of the audio signal inputted to the audio encoding unit is removed, so that the easily audible call receiving sound can be recorded and reproduced.

Further, in the portable telephone according to the present invention, a musical scale adjusting unit is desirably provided for adjusting the musical scale of the audio signal inputted to the audio encoding unit.

The musical scale of the audio signal inputted to the audio encoding unit is adjusted. Thus, since the tone quality of the recorded call receiving sound can be freely changed, the enjoyment of a user is increased.

### BRIEF DESCRIPTION OF THE DRAWING

FIG. 1 is a block diagram showing a first embodiment of a portable telephone of the present invention.

FIG. 2 is a block diagram showing a second embodiment of a portable telephone of the present invention.

In the drawings, reference numeral 100 designates a portable telephone, 110 designates a radio communication part, 120 designates a DSP part (an audio recording unit), 121 designates a communication control part(a communication control unit), 122 designates a digital audio signal processing part, 123 designates an audio processing part, 123a designates a musical scale shifter part (a musical scale adjusting unit), 123b designates an audio adaptation part (a noise component removing unit), 124 designates a sound volume and musical scale setting part, 130 designates an audio processing part, 131 designates a transmitted audio input terminal, 132 designates a reproduced sound output terminal, 135 designates an AD converter, 136 designates an audio output circuit, 140 designates an audio encoding/decoding part, 141 designates an encoding part (an audio encoding unit), 142 designates a decoding part (an audio decoding unit), 150 designates a storing part, 150a designates a received audio data storing area (an audio recording unit), 150b designates an ADPCM encoded data storing area (an encoded data storing unit), 180 designates a microphone ( a sound picking up unit), 181 designates a speaker (a call receiving sound output unit) and 200 designates a portable telephone.

### BEST MODE FOR CARRYING OUT THE INVENTION

Now, embodiments of the present invention will be described below.

### First Embodiment

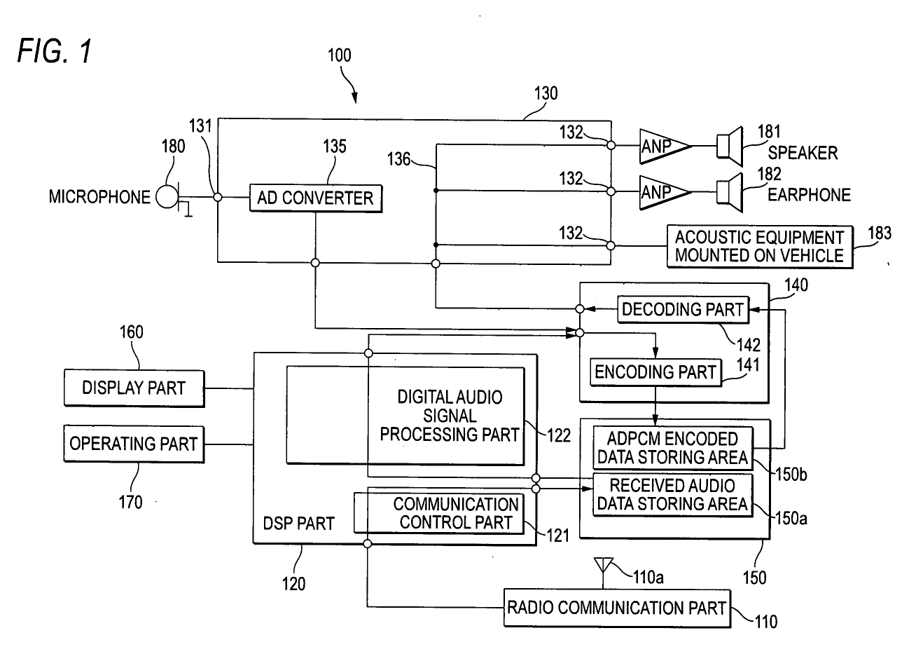

FIG. 1 is a block diagram showing a first embodiment of a portable telephone according to the present invention.

This portable telephone 100 comprises a radio communication part 110, a DSP part 120, an audio processing part 130, an audio encoding/decoding part 140, a storing part 150, a display part 160 and an operating part 170.

The radio communication part 110 has an antenna 110a to perform a radio communication with a base station that is not shown in the drawing. That is, the radio communication part 110 superimposes a transmitted audio signal on a carrier wave to generate a radio signal and transmits the radio signal to the base station through the antenna 110a. The radio communication part 110 receives the radio signal sent from the base station through the antenna 110a and demodulates the radio signal to obtain a received audio signal.

The DSP part 120 includes a communication control part 121 and a digital audio signal processing part 122. The communication control part 121 controls the radio communication part 110 to switch the base station (refer it to as to switch a channel, hereinafter) and detect a received call and connect/disconnect a call. Further, the communication control part 121 also has a function for converting the received audio signal received by the radio communication 110 to digital audio data (received audio data) of a type that can be stored in the storing part 150 and outputting the digital audio data to the storing part 150. The digital audio signal processing part 122 converts the digital audio data (received audio data) from the storing part 150 to data of a type that can be processed in the audio encoding/decoding part 140.

The audio processing part 130 includes a transmitted audio input terminal 131 and a plurality of reproduced audio output terminals 132. To the transmitted audio input terminal 131, a microphone 180 for picking up external sound such as the voice of a user is connected. To one of the plurality of reproduced audio output terminals 132, a speaker 181 is securely connected. To other reproduced audio output terminals 132, an earphone 182 or an acoustic equipment 183 mounted on a vehicle is connected as required.

In the audio processing part 130, the AD converter 135 is provided. An analog audio signal picked up by the microphone 180 is converted to digital audio data (picked up audio data) in the AD converter 135 and the digital audio data is outputted to the audio encoding/decoding part 140. Further, in the audio processing part 130, an audio output circuit 136 is provided for distributing and outputting a reproduced analog audio signal sent from the audio encoding/decoding part 140 to the plurality of reproduced audio output terminals 132.

The audio encoding/decoding part 140 includes an encoding part 141 and a decoding part 142. The encoding part 141 encodes (μ-law-linear conversion) the digital audio data from the DSP 120 or the audio processing part 130 to the linear data of an ADPCM system (refer it to as ADPCM encoded data, hereinafter) and outputs the linear data to the storing part 150. The decoding part 142 decodes the ADPCM encoded data from the storing part 150 to the analog audio signal and outputs the analog audio signal to the audio processing part 130.

The storing part 150 is provided with a received audio data storing area 150a for storing the digital audio data from the DSP part 120 and an ADPCM encoded data storing area 150b for storing the ADPCM encoded data from the audio encoding/decoding part 140.

In the display part 160, information related to the state of the portable telephone 100 (the state of radio wave, a residual quantity of a battery, etc.), various kinds of menu screens, various kinds of input screens or the like is displayed.

The operating part 170 includes an on-hook button, an off-hook button, a dial button, a direction instructing button, an execution button, various kinds of function selecting buttons, etc. The various kinds of function selecting buttons include a button for changing external sound to call receiving sound and a button for changing received sound to a call receiving sound or the like.

The above-described radio communication part 110, the DSP part 120, the audio processing part 130, the audio encoding/decoding part 140 and the storing part 150 are respectively formed with separate circuit blocks (IC chips). Accordingly, even when the DSP part 120 is reset, the operation of the audio encoding/decoding part 140 is not absolutely influenced thereby.

Now, an operation of the portable telephone 100 of the first embodiment constructed as described above will be described below. Since a communication function of the portable telephone 100 is the same as that of an ordinary telephone, an explanation thereof is omitted. Here, only a function for picking up external sound such as the voice of a user and using it as a call receiving sound and using the voice of a partner to talk with a user, that is, using received sound of a partner to talk with the user as the call receiving sound will be described below.

[Change of External Sound to Call Receiving Sound]

During a non-communication state, when the button for changing the external sound to the call receiving sound of the operating part 170 is pressed, a function for picking up the external sound such as the voice of the user by the microphone 180 is activated. The analog audio signal picked up by the microphone 180 is converted into the digital audio data by the AD converter 135 in the audio processing part 130. The digital audio data is encoded in accordance with the ADPCM system by the encoding part 141 in the audio encoding/decoding part 140 and stored in the ADPCM encoded data storing area 150b in the storing part 150.

[Change of Received Sound to Call Receiving Sound]

During a communication state, when the button for changing the received sound to the call receiving sound of the operating part 170 is pressed, a function (audio memory function) for storing the voice of the partner to talk with the user that is received by the radio communication part 110 in the received audio data storing area 150a in the storing part 150 is activated. The received audio data from the radio communication part 110 is converted into the digital audio data of a prescribed form by the communication control part 121 in the DSP part 120 and stored in the received audio data storing area 150a of the storing part 150. The digital audio data stored in the received audio data storing area 150a is converted to data of a prescribed form by the digital audio signal processing part 122 in the DSP part 120 after the communication, then, encoded in accordance with the ADPCM system by the encoding part 141 in the audio encoding/decoding part 140 and stored in the ADPCM encoded data storing area 150b in the storing part 150.

[Reproduction of Call Receiving Sound]

When the communication control part 121 in the DSP part 120 detects a received call, ADPCM encoded data stored in the ADPCM encoded data storing area 150b in the storing part 150 is read and sent to the decoding part 142 in the audio encoding/decoding part 140. Then, the ADPCM encoded data is sequentially decoded to the analog audio signal in the decoding part 142 and outputted as call receiving sound from the speaker 181 or the like via the audio output circuit 136 in the audio processing part 130. This call receiving sound reproducing operation is continued until the off-hook button of the operating part 170 is pressed or a recording function during an absence operates.

As described above, in the first embodiment, the external sound picked up during the no-communication or the voice of the partner to talk with the user recorded during speaking can be used as the call receiving sound. Further, the decoding operation of the ADPCM encoded data by the audio encoding/decoding part 140 is not influenced by a reset operation due to the non-synchronous operation of the DSP part 120 in view of the structure of circuit blocks. Accordingly, even when the channel is switched during reproducing the call receiving sound, the break of the call receiving sound can be avoided.

Further, since the ADPCM system is employed as an encoding/decoding system of an audio signal in the audio encoding/decoding part 140, a quantity of audio data to be stored can be decreased as much as possible. Thus, a memory capacity necessary for the storing part 150 can be suppressed. Accordingly, the increase of the memory capacity of the storing part 150 due to the change of the external sound or the received voice or sound to the call receiving sound can be suppressed to a minimum and the increase of a parts cost can be suppressed.

### Second Embodiment

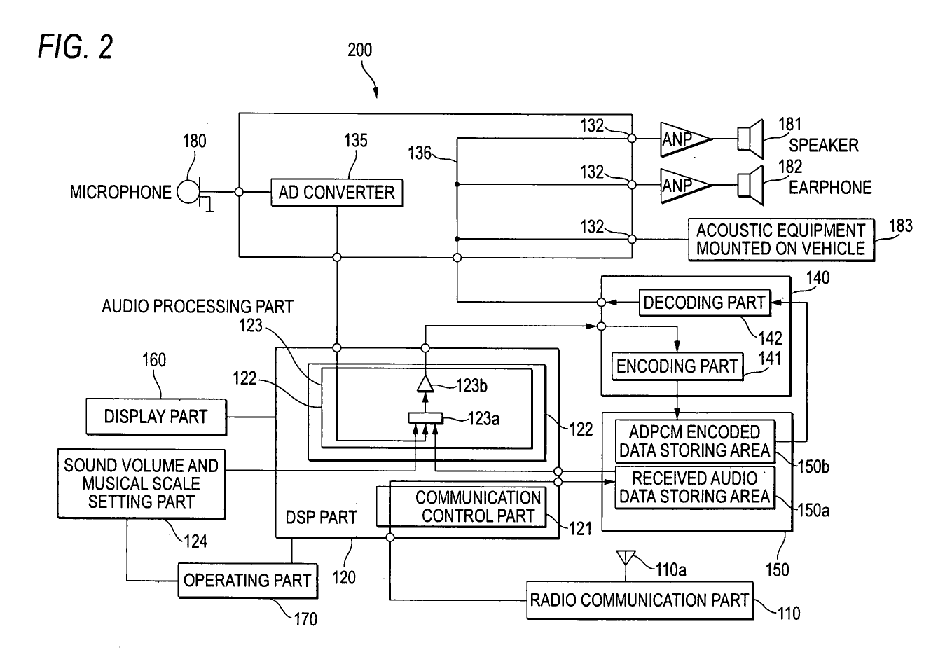

FIG. 2 is a block diagram showing a second embodiment of a portable telephone according to the present invention. This portable telephone 200 includes an audio processing part 123 and a sound volume and musical scale setting part 124 in addition to the structure of the first embodiment shown in FIG. 1. Further, digital audio data from an audio processing part 130 is inputted to an audio encoding/decoding part 140 via the audio processing part 123.

The audio processing part 123 is formed as a part of a digital audio signal processing part 122 in a DSP part 120 and includes a musical scale shifter part 123a for adjusting the musical scale of the digital audio data inputted to the audio encoding/decoding part 140 and an audio adaptation part 123b for adjusting sound volume and an equalizer and removing a noise component.

The musical scale shifter part 123a performs a frequency conversion (musical scale shift) process to the inputted digital audio data in accordance with a musical scale setting value instructed from the sound volume and musical scale setting part 124 and delivers the processed digital audio data to the audio adaptation part 123b. The musical scale of original audio is shifted to a high-pitched tone side (in the case of setting to+side or a low-voice side (in the case of setting to−side) in accordance with the frequency conversion process.

The audio adaptation part 123b carries out an addition and subtraction (adjust sound volume and an equalizer) process of sound volume data to the digital audio data from the musical scale shifter part 123a in accordance with the musical scale setting value instructed from the sound volume and musical scale setting part 124. Further, the audio adaptation part 123b deletes data not higher than a prescribed sound volume level (remove a noise component) and outputs the processed data to an encoding part 141 of the audio encoding/decoding part 140.

The sound volume and musical scale setting part 124 employs an operating signal from an operating part 170 as an input and instructs the setting values of sound volume and the musical scale to the audio processing part 123 in accordance with the operating signal. The setting values of the sound volume or the musical scale are displayed on a display part 160. While a user recognized the recorded sound volume on the display part 160, the user adjusts the setting value of the recorded sound volume. The setting value of the recorded sound volume is changed, so that even when the sound volume of external sound or received sound is too high or too low, the sound volume data of the recorded digital audio data can be properly adjusted. Further, the setting value of the musical scale is changed so that the tone quality of the recorded digital audio data can be changed to a tone quality different from an original audio.

When the musical scale is adjusted, on the display part 160, icons such as “+shift”. “−shift”, “man's voice”, “woman's voice”, “child's voice”, etc. are displayed as operating elements for setting the musical scale. The icons can be selected in such a way that the user operates a direction instructing button or the like. The selection can be determined and instructed by an execution button. The “+shift” or the “−shift” is instructed so that the musical scale of original voice or sound can be arbitrarily shifted to the high-pitched tone side or the low voice side. When the “man's voice”, “the woman's voice” or the “child' voice” is instructed, the musical scale of the original voice or sound can be shifted by a preset quantity of shift to the high-pitched tone side or the low voice side.

An operation of the portable telephone of the second embodiment constructed as described above will be described below.

[Change of External Sound to Call Receiving Sound]

During a non-communication state, when a prescribed button of the operating part 170 is operated to set the sound volume and the musical scale and then a button for changing external sound to a call receiving sound is pressed, a function for picking up the external sound such as the voice of the user by a microphone 180 is activated. An analog audio signal picked up by the microphone 180 is converted into the digital audio data by an AD converter 135 in the audio processing part 130 and then, the digital audio data is inputted to the audio processing part 123. In the audio processing part 123, the musical scale is adjusted by the musical scale shifter part 123b, the sound volume is adjusted by the audio adaptation part 123a, an equalizer is adjusted and a noise component is removed relative to the inputted digital audio data. Then, the digital audio data outputted from the audio processing part 123 is encoded in accordance with an ADPCM system by the encoding part 141 in the audio encoding/decoding part 140 and stored in an ADPCM encoded data storing area 150b in a storing part 150.

[Change of Received Sound to Call Receiving Sound]

During a communication state, when the prescribed button of the operating part 170 is operated to set the sound volume and the musical scale, and then, a button for changing received sound to call receiving sound is pressed, a function (audio memory function) for storing the voice of a partner to talk with the user that is received by a radio communication part 110 in a received audio data storing area 150a in the storing part 150 is activated. The received audio data from the radio communication part 110 is converted into the digital audio data of a prescribed form by a communication control part 121 in a DSP part 120 and stored in the received audio data storing area 150a of the storing part 150. The digital audio data stored in the received audio data storing area 150a is inputted to the audio processing part 123 after the communication is completed. In the audio processing part 123, the musical scale is adjusted by the musical scale shifter part 123b, the sound volume is adjusted by the audio adaptation part 123a, an equalizer is adjusted and a noise component is removed relative to the inputted digital audio data. Then, the digital audio data outputted from the audio processing part 123 is encoded in accordance with the ADPCM system by the encoding part 141 in the audio encoding/decoding part 140 and stored in the ADPCM encoded data storing area 150b in the storing part 150.

[Reproduction of Call Receiving Sound]

When a call is received, the audio data of external sound or received sound in which the musical scale is adjusted and the sound volume is adjusted as described above is read from the ADPCM encoded data storing area 150b in the storing part 150 upon receiving the call and outputted as call receiving sound in the same manner as that of the first embodiment.

As described above, in the second embodiment, the audio adaptation part 123b is provided for removing the noise component of the digital audio data inputted to the audio encoding/decoding part 140. Thus, easily audible call receiving sound can be recorded and reproduced.

Further, the musical scale shifter part 123a is provided for adjusting the musical scale of the digital audio data inputted to the audio encoding/decoding part 140. Thus, the tone quality of the call receiving sound using the external sound or the received sound can be freely changed so that the enjoyment of the user can be increased.

In the above-described embodiment, the sound volume of the recorded audio data is set by operating the operating part 170 by the user. However, an input sound volume detecting part for detecting the sound volume of the inputted audio data may be provided in a preceding stage to the audio adaptation part 123b so that the audio adaptation part 123b automatically adjust the recorded sound volume so as to be always a constant value even when the sound volume of the inputted audio data is changed.

The encoding system in the audio encoding/decoding part 140 is not limited to the μ-law-linear conversion.

Further, the radio communication part 110, the audio processing part 130, the audio encoding/decoding part 140 and the storing part 150 may be formed with the same circuit block (IC chip).

Although the present invention is described specifically by referring to specific embodiments, it is apparent for a person with ordinary skill in the art that the various kinds of changes or modifications may be added thereto without departing from the spirit and scope of the present invention.

This application is based on Japanese Patent Application No. 2003-015086 filed in Jan. 23, 2003 and the contents thereof is taken in this application as a reference.

### INDUSTRIAL APPLICABILITY

As described above, in the portable telephone according to the present invention, the external sound or the voice of a partner to talk with a user can be used as a call receiving sound. Even when the base station is switched during reproducing the call receiving sound, the break of the call receiving sound can be avoided.

1. A portable telephone comprising:
a sound picking up unit for picking-up external sound;
an audio encoding unit for encoding an audio signal picked up by the sound picking up unit;
an encoded data storing unit for storing the audio data encoded by the audio encoding unit;
an audio decoding unit for decoding the audio data stored in the encoded data storing unit;
a call receiving sound output unit for outputting the audio data decoded by the audio decoding unit as a call receiving sound; and
a communication control unit for switching a base station, characterized in that the function of the audio decoding unit is provided in another circuit block that does not depend on the operation of a circuit block functioning as the communication control unit.

2. A portable telephone comprising:
an audio recording unit for recording an audio signal of a partner to talk with;
an audio encoding unit for encoding the audio signal recorded by the audio recording unit;
an encoded data storing unit for storing the audio data encoded by the audio encoding unit;
an audio decoding unit for decoding the audio data stored in the encoded data storing unit;
a call receiving sound output unit for outputting the audio data decoded by the audio decoding unit as a call receiving sound; and
a communication control unit for switching a base station, characterized in that the function of the audio decoding unit is provided in another circuit block that does not depend on the operation of a circuit block functioning as the communication control unit.

3. The portable telephone according to claim 1 or 2, characterized in that the audio encoding unit encodes the inputted audio signal by an ADPCM system and the audio decoding unit decodes the inputted audio data by the ADPCM system.

4. The portable telephone according to claim 1, 2 or 3, characterized in that a noise component removing unit is provided for removing the noise component of the audio signal inputted to the audio encoding unit.

5. The portable telephone according to claim 1, 2 or 3, characterized in that a musical scale adjusting unit is provided for adjusting the musical scale of the audio signal inputted to the audio encoding unit.
